(19) United States
(12) Patent Application Publication
(10) Pub. No.: US 2010/0274795 A1
(43) Pub. Date: Oct. 28, 2010

(54) METHOD AND SYSTEM FOR IMPLEMENTING A COMPOSITE DATABASE

(75) Inventors: Prasad V. Rallapalli, Pleasanton, CA (US); Jun Yang, Cupertino, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/428,367

(22) Filed: Apr. 22, 2009

(51) Int. Cl. G06F 17/30; G06F 15/82

(52) U.S. Cl. 707/769; 709/206

(57) ABSTRACT

Methods and systems are provided that may be used to selectively implement and/or search a composite database comprising a flat file and a relational database based on the query.

### BACKGROUND

1. Field

The subject matter disclosed herein relates to a composite database.

2. Information

A database may store data in various files. For example, metadata associated with electronic mail messages may be stored in files in a database. Metadata may include information relating to electronic mail messages in a particular user's electronic mail box. To find a particular message, a user may submit a query to search a file containing metadata to locate an associated electronic mail message. For example, a user may submit a query to search for messages from the sender, “fakelogin@xxxxxxx.com.”

A file may store metadata for at least some messages. A file may be stored in blocks of data in a database accessible by a server. In the event that a file is large, a server may selectively access and retrieve various blocks of data in the file to perform a search. A particular way in which a search is performed may greatly affect overall system performance. For example, if many data blocks in a file have to be accessed and retrieved from a database, overall system performance may decrease dramatically, introducing latency that may be noticeable and annoying to an end user of a particular electronic mail program, for example.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic diagram of a messaging system according to one implementation.

FIG. 2 illustrates a flat file according to one particular implementation.

FIG. 3 is a schematic diagram of a processing system according to one implementation.

FIG. 4 is a flow diagram illustrating application of a composite database according to one implementation.

FIG. 5 is a schematic diagram of a computing environment system that may include one or more special purpose computing devices to perform a search using one or more techniques illustrated above, for example, according to one implementation.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

In one implementation, a composite database is provided that combines features of both a set of flat files and one or more relational databases. Such a composite database may achieve superior performance, on average, than would be possible if such a database were comprised entirely of flat files or entirely of one or more relational databases.

A composite database, as discussed herein, may combine advantages of data storage and retrieval using a set of flat files with the advantages of using relational databases for data storage and retrieval. Such a composite database may also utilize an optimized Structured Query Language (SQL) based access from an executed application program that hides complexity of the underlying physical implementation. Such a composite database may implement a logical schema in multiple physical schemas—e.g., using both a set of flat files and a relational database.

A “flat file,” as used herein may refer to a file containing a set of records. A flat file may, for example, be searched according to a sequential process in which each successive record is read/examined until a record (or records) containing a desired search term is located. Flat files effectively store bytes, with a specific meaning associated with each set of bytes, dependent upon a particular application program. For example, certain bytes in a flat file may be associated with a first type of information (referred to herein as a “data field”), whereas other bytes may be associated with a different data field. A data record may be viewed as a set of such data fields. A flat file of addresses, for example, may include, for example, various fields (e.g., sets of bytes) representative of the name of a person, street number, street, city, zip code, and so forth. A flat file may include data written in record fashion, one data record after the other without any gaps, in an order predefined by an executing application program, for example.

A “relational database,” as used herein, may refer to a database which organizes data records (e.g., referred to herein as “rows”) into tables in such a way that specific fields (e.g., referred to herein as “columns”) from rows of such tables of interest may be accessed both serially/sequentially and randomly, quite efficiently. A relational database may store large amounts of data in one or more relational database tables and one or more indexes, such as b-tree based indexes. An index may store one or more attributes (e.g., columns) of a particular relational data table, and may be defined and populated in the database. These relational database tables and indexes and other data structures are referred to herein as “relational database objects.” Fields of complete data records (e.g., rows) may be added, changed, deleted and fetched from relational database tables using Structured Query Language (SQL) Insert, Update, Delete and/or Select statements.

Relational data tables may be used to more efficiently store and search for data as compared to similar data stored in a flat file, for certain types of queries. A relational database may group data into physical structures called “relational database tables,” using common attributes and inter-relationships found in the structure of the data to be stored and retrieved. A relational database may include one or more indexes defined on a relational data table. Each such index may be defined over one or more columns (attributes) of data stored in a relational data table. The blocks of such an index (e.g., referred to herein as “index blocks”) may contain pointers to the blocks of the relational data table (e.g., referred to herein as “data blocks”) for a given value or range of values of indexed columns of a relational data table. In one implementation such a relational database index may use a data structure referred to herein as a “b-tree.”

Both flat files and relational databases have complementary advantages and disadvantages. Flat files do not support indexed access to specific data records and random retrieval and update of data records is not feasible because the data record size may change as a result of an update (because the entire file would have to be rewritten for each such update). However, flat files are simple to use and are an efficient data structure for adding (inserting) new data records, as this may be done at the end of the file. Performing a large number of such data record inserts very efficiently may be a time critical workload for electronic mail metadata storage and retrieval systems, as efficient, timely delivery of messages (and their related metadata) to an email account (or address) is a goal in such systems.

Data stored in relational database tables can be modified using appropriate SQL statements. Such database software may support such changes with what are called ACID (i.e., Atomicity, Consistency, Isolation, and Durability) properties. In one implementation, maintaining these ACID properties of transactions depends on “write ahead logging” (WAL). For example, before an update is performed, the content of a data record (or records) from the relational table (or tables) being altered (usually referred to as a “before image”) may first be written to a separate file called a “database log.” After the data is changed in the requisite relational data tables and related indexes, the content of the records after the desired changes (called the “after image”) may also be written to the database log. Because of the additional Input/Output requests (“I/O's”) required for writing the before and/or after images of the relational database table rows being changed in the transaction, WAL may require many times more I/O's to service, even for a single record update/delete transaction.

Similarly, maintenance of relational indexes when indexed columns are updated or rows are inserted into the tables may require additional I/O's. Thus, a relational database implementation may require significantly more I/O's as compared to storing the same data records in a flat file implementation, but offers more flexibility and faster access to desired records for certain queries (referred to as “index matching queries”) that can be processed using available indexes. As mail message metadata access is I/O bound, reducing I/O may be a critical success factor to deliver market leading performance required from the back end systems underlying large email systems.

“Data,” as used herein, may refer to accessible information, records, or fields within a record, to name just a few among many examples. Data may be stored as binary digital signals in one or more memories or other storage devices. Data may be partitioned and accessed across physical schemas using application specific metadata, in a data-driven, transparent manner. A composite database may be viewed as comprising a set of composite database tables and related objects. Data records in a composite database table may be physically stored internally in one or more (i.e., within a set of) flat file virtual tables and in a related set of one or more relational database tables. Indexes and other objects may be defined over a composite database table to facilitate efficient access to data stored in the composite database tables using SQL queries and transactions. A composite database may enable optimized SQL queries and transactions to either or both the underlying physical organizations for a given composite database table, in a seamless manner as if it were a single relational table, using a combination of one or more flat file virtual tables and one or more related relational database tables.

“Metadata,” as used herein, may refer to data or other information which describes other types of information about data. In other words, metadata is data about data. Metadata may be transmitted to a database via a signal, for example. In one example, metadata may include information about certain attributes of a message, such as information describing a message, without including text of such a message itself. Metadata for a message may include, for example, information descriptive of a message sender, message recipient, message size, and time that a message was sent, mime type, or whether there are attachments and how many attachments, to name just a few among many examples. In the context of a messaging system, metadata may describe characteristics or other aspects of a message.

A method and system, as discussed herein may be utilized to efficiently store, maintain and search for data, such as metadata, relating to a messaging system in one particular implementation. Data relating to such a messaging system, or transactional or other system, may be maintained in a composite database. Content of the data in a composite database table may be partitioned into the data stored in one or more flat file virtual tables and one or more relational database tables, based on predefined criteria. Such a data partitioning schema may be seamless and hidden from an end user or process desiring to search for data records related to messages satisfying a particular set of search conditions.

For mail message metadata storage and retrieval systems, critical workloads may include message delivery (which requires inserts to metadata stored in the composite database), fetch of one or more most recent messages (e.g., most recent 300 messages), delete/update of metadata of recent messages that are likely to be read, forwarded, or deleted. Storing metadata pertaining to such most recent messages in a composite database table may be more efficient if such data is stored initially in one or more corresponding flat file virtual table(s) underlying the composite table and then moving such data, maintaining appropriate controls to ensure integrity, to the one or more related relational database tables underlying the composite database table, after a certain time has elapsed or based on other configurable criteria (e.g., criteria that can be data and policy driven to meet the overall system performance requirements). The flexibility of the underlying composite database table may enable such a system to achieve better overall system I/O performance than would be possible from a system designed using only a set of flat files or only a set of relational database objects.

A composite database may also be utilized to store data or other information associated with a messaging or other electronic transaction-based system, such as a banking transaction system. A composite database may be implemented based on signals stored in a memory device, for example. Such a memory device may include a volatile memory device, such as Random Access Memory (RAM), or a nonvolatile memory device, such as a flash memory device used in mobile devices such as laptop computers and cell phones, for example. Information stored in a database may include metadata or other transaction-related data.

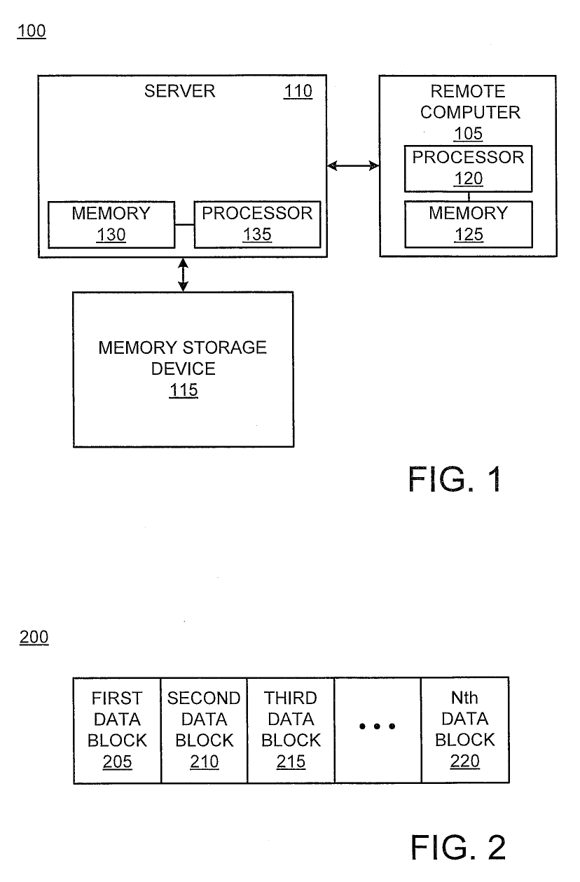

FIG. 1 illustrates a messaging system 100 according to one implementation. As shown, messaging system 100 may include devices such as a remote computer 105, a server 110, and a memory storage device 115. Remote computer 105 may include a processor 120 and a memory 125. Remote computer 105 may execute an application program, such as a web browser, for example, to view a web-based electronic mail program. Remote computer 105 may be in communication with server 110 over an electronic communication network using any one of several communication protocols, such as, for example, Transmission Control Protocol (TCP)/Internet Protocol (IP). Server 110 may include a memory 130 and a processor 135.

A web-based electronic mail program may display electronic mail messages in a particular user's electronic mail box, for example. Such messages may be stored in a memory storage device 115 accessible by server 110. Memory storage device 115 may store signals representative of features of a database. Memory storage device 115 may also store signals representing metadata associated with such messages, for example. Here, a user may search for messages having certain specified metadata characteristics, such as a particular date or message sender. Such information may be searchable in a file containing metadata associated with a user's web-based electronic mail program. In a particular embodiment in which a user has accumulated a large number of messages, a file containing metadata for an electronic mail program may be relatively large. Such a file may be accessed by transferring data blocks (e.g., as represented by signals stored in memory) of a file from memory storage device 115 to server 110. Server 110 may search within a retrieved data block for the data records satisfying a particular search query.

A “data block,” as used herein, may refer to a sequence of bytes or bits, having a predefined length. For example, the first 32 Kbytes in a file may comprise a first data block in the file, and the next 32 Kbytes may comprise a second data block, and so forth.

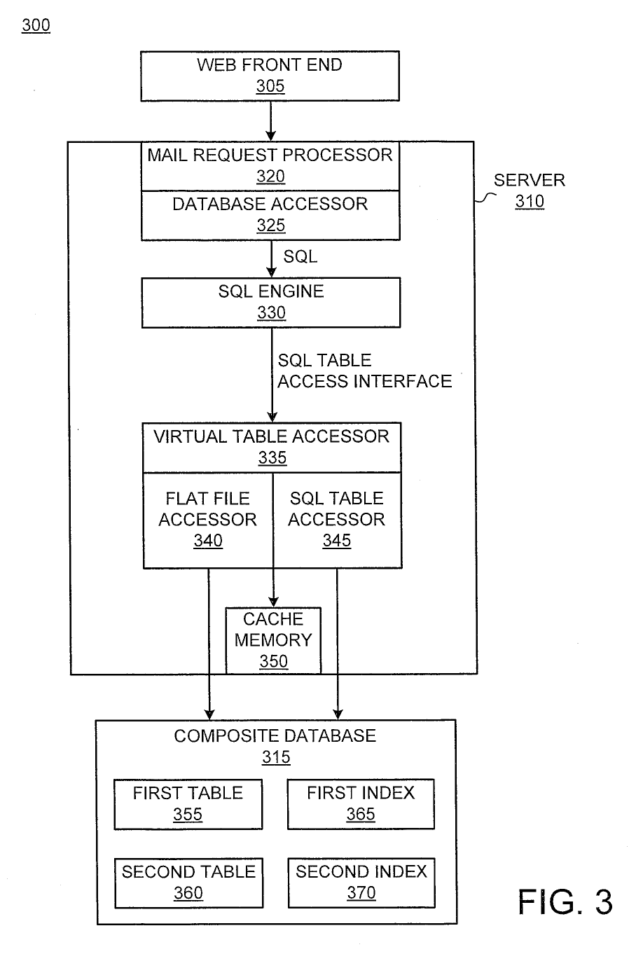

FIG. 2 illustrates a flat file 200 according to one particular implementation. As shown, flat file 200 is comprised of various sequential data blocks, such as first data block 205, second data block 210, third data block 215, and an Nth data block 220. Flat file 200 may be stored as signals representing a database on a hard disk, or on some other accessible storage device such that data blocks may be selectively retrieved in response to searches for certain terms, such as metadata terms, contained within the data fields of the data records stored in such data blocks.

In one example, a flat file may include two data fields—a first data field for a name and a second data field for an address. If one wanted to just search for a name, such as the name “Joe,” for example, there may not be a way to efficiently search for this term in a flat file. In order to search for the first record that has “Joe” in the Name field (column), all the records in the flat file may need to be read. In other words, the entire flat file may need to be sequentially searched from the first byte until the last byte until the first record having term “Joe” in the Name field is found. All the records would need to be read if the query were to look for all records having the value “Joe” in the Name field. Accordingly, data blocks for a flat file may be sequentially fetched and searched until the desired data record (or records) containing such a term is (or are) found. A flat file may not have a table or index of search terms or keywords associated with it. Accordingly, it is not possible to directly read the desired data block (or blocks) of data records having the desired value in the desired field within their record (or records). This inability to efficiently do what is called a “random search” for data records containing arbitrary user specified values for arbitrary set of data field (or data fields) makes a flat file record store less desirable, because many email systems need to perform such random searches very efficiently.

As discussed above, if data stored on a disk is to be accessed, for example, such data may be accessed and retrieved via data blocks. A data block may contain many records, and a size for such a data block may be fixed for a given implementation. For example, if a search is being performed to find the first record (and implicitly the data blocks containing the record) that meets a given search criterion, using a data storage and retrieval system where the desired record is found in the very first data block retrieved from the storage system would be an ideal situation. However, this may not always be the case and sometimes it may be necessary to fetch several data blocks before a particular data block containing one or more records that meet a given search criterion is found. In the worst case, all the data blocks maintained in the entire data storage and retrieval system may be retrieved, but with no record matching the desired search criterion (or criteria).

Efficiency in locating a relevant block of data from a block oriented storage device such as a hard disk may be characterized based on a “Big ‘O’ notation.” A “Big ‘O’ notation,” as used herein, may refer to a number of blocks accessed to answer a given query (e.g., to find the zero or more data records stored in the system that meet the desired search condition or conditions). The “O” in the notation may refer to an order of magnitude. “O(1)” may indicate that the number of data blocks accessed to answer a given query is just one block. However, “O(n),” may indicate that n (or some scalar multiple or fraction of n) blocks would need to be scanned to locate the records that satisfy the given query. Big “O” notation may be used to compare average, best, and/or worst case scenario I/O costs for retrieving a data block containing the records that satisfy a given query or data operation in various alternative data storage and retrieval systems, such as a relational database system or a flat file based system.

In a worst case performance, a Big “O” notation of efficiency of a search is O(n), e.g., where all n blocks of data in the data structure may need to be read. For a flat file, an average search efficiency may be n/2 I/O operations. Statistically speaking, on average, data records satisfying an arbitrary search condition may be located by fetching an average of half of the total number of data blocks.

Another type of database which may be utilized to store metadata or other information relating to a messaging system is a relational database. Relational databases may be tailored for certain types of data access. Data is stored in a table data structure in a relational database. A relational table may have a pre-defined set of columns corresponding to the attributes or fields of the records stored in that table. A relational database may contain an index that maps the values of the indexed columns of the relational data table to certain data blocks containing the corresponding rows of the table. In one implementation, relational database indexes may use a b-tree data structure for efficient storage and retrieval of the indexed values.

A “b-tree database,” as used herein may refer to a relational database utilizing a b-tree data structure that keeps indexed data sorted and allows index-matching searches, insertions, and deletions in logarithmic amortized time. Unlike self-balancing binary search trees, it is optimized for systems that read and write large blocks of data. In a b-tree database, internal (non-leaf) nodes may have a variable number of child nodes within some pre-defined range. When data is inserted or removed from a node, its number of child nodes changes. In order to maintain the pre-defined range, internal nodes may be joined or split.

A b-tree database, for example, may utilize an index that tracks keywords or certain common search terms or attributes so that upon performing a search, an average I/O performance much better than n/2 (or O(n)) may be achieved. A b-tree database may be searched to locate relevant records more efficiently than doing the same operation on a flat file data storage and retrieval system. On average, a best case and a worst case scenario may have the same Big “O” notation performance for a b-tree based index, which is log_{b} n, where n is the number of blocks in the file, and the base of the logarithm is b. The base b may also be referred to as a “fill factor,” e.g., indicating how many of the keys (indexed values) fit in one index block. A “key” may refer to a column or field of interest that has a distribution of data such that it can be used to find data more quickly. If, for example, records stored include a name and an address, where a name is stored in 10 bytes and an address is stored in 90 bytes, a full record may therefore encompass 100 bytes (i.e., a combination of a 10 byte name and a 90 byte address). If a block has a size of 1000 bytes, ten of such full records may be stored in a block. Such a block therefore has a “fill factor” of 10. However, if only the values of the name are stored in the index, a block of 1000 bytes could store one hundred names and such an index block would have a fill factor of 100.

A name or address may be stored in a field, in one particular example. If a name is a field of interest, 100 keys (where each key is 10 bytes in size, i.e., the size of a name) could be filled in one 1000 byte block. A base for a Big “O” notation for such a b-tree database would therefore be 100, e.g., the number of keys that on average would fit in the index block. N would be the number of blocks in the entire data structure (e.g., b-tree or flat file) being accessed. If there are 1,000,000 records in a flat file, a 1000 byte block size, and each record is 100 bytes, 10 records would therefore fit into one data block, and the number of data blocks in the entire flat file would therefore be 1/10 of 1,000,000 records, or 100,000. A sequential search would, on the average, visit half of these blocks, i.e., 50,000 blocks. The average insert/delete/select performance on a b-tree data structure is log_{b} N. Given a key size of 10 bytes and index block size of 1000 bytes, the fill factor (i.e., the base of the logarithm) b is 100. The 1 million keys would require 10,000 index blocks. In this example, log₁₀₀ 0000=2, e.g., any key in the index may be fetched from the b-tree index using just 2 I/O's. Adding the fetch of the data record containing the desired key pointed to by the b-tree index enables one to estimate that a total of three I/O operations may be required—two to fetch the correct index block and one to get the data block to search the b-tree database for a given search criterion. Thus, with just three fetches, a data record containing any name in this b-tree index based relational database containing a million records may be retrieved. If, on the other hand, such records were stored in a flat file, the average number of fetches to find the correct data block would be much higher—N/2, or 50,000 fetches. This example highlights the relative I/O efficiency (e.g., just three versus 50,000 I/O's in this example) of accessing data satisfying a search criterion using a b-tree index based relational database table access as compared to using a flat file.

A composite database table, as discussed herein, may have numerous advantages over a data storage and retrieval system comprising only a single flat file, for example. Just like a flat file based system, a composite database table offers simple and efficient data storage and retrieval operations as characterized by a best case performance of O(1) and a worst case O(B) performance for inserts, selects, or updates of a single record in a flat file virtual table of B blocks. However, unlike a flat file, such a composite database may support efficient execution of complex select queries such as sorting and/or selection by any combination of fields, enable efficient random record queries, enable a simple addition of new fields or modifications of the data structure of a data record stored in the composite database tables, enable easy addition of new indexes to speed up searching for data stored in the composite database table for certain queries, and enable efficient indexed access to the data stored in the composite database.

A composite database may also include advantages inherent in a b-tree relational database. For example, a composite database table may be I/O efficient, with a performance of O (log_{b} N) I/O's (just like traditional relational table b-tree based index matching queries) and, in addition to supporting such efficient data access using queries, may also enable composite database transactions. A composite database may support such queries and transactions written using SQL statements and commands. Such composite database transactions may support ACID properties, typically desired in relational database transactions. Typically such transactions may involve changes to the data stored in one more composite database tables within a composite database. Such changes may include adding zero or more data records (e.g., also known as Insertions), deleting zero or more data records, updating zero or more existing data records while preserving these ACID properties.

Unlike relational database tables, however, such a composite database may avoid the k*[O (log_{b} N)] insertion or deletion related I/O costs required to maintain k b-tree indices for a traditional database table whose keys are stored in N blocks. In a relational table having a b-tree index, the index entries would need to be maintained for each insert of a data record (row) in the relational table. Thus, an insert of a row into a relational database table having k b-tree indexes each having N blocks would cost O(log_{b} N) I/O's per insert into each of the k indexes, making a total index maintenance overhead of k*[O(_{logbN})] I/O's in such b-tree based relational databases.

Such a composite database may also provide greater availability, operational flexibility, enable granular data record migration, and support multiple schema versions, and may also be backward compatible with older versions of the data storage and retrieval systems that may use flat files.

A composite database, as discussed herein, may store certain data in a set of appropriate internal flat file virtual tables as a first portion of a database, and store the remainder of such data in a set of related internal relational database tables. In the event that such data is metadata, metadata most likely to be accessed may be stored in an appropriate internal flat file virtual table, and metadata less likely to be accessed may be stored in an appropriate internal relational database table. A reason for storing metadata most likely to be accessed in an appropriate internal small flat file virtual table is because a data block containing a desired search term may be located and retrieved more quickly from such a small flat file than from an appropriate internal relational database table even if b-tree based indexes are used to efficiently search such relational database tables. Metadata most likely to be accessed may be determined based on a heuristic analysis of the search queries, for example.

In one implementation, metadata for email messages dated within the previous four weeks, for example, may be stored in an internal flat file virtual table, whereas metadata for older email messages may be stored in an internal relational database table. Such a partition may therefore exploit time locality of access if, for example, it is determined that a user is more likely to desire to access metadata associated with more recent messages than with metadata associated with older messages. Metadata may be partitioned between appropriate internal flat file virtual tables and a related set of appropriate internal relational database tables based on other criteria such as the presence of certain predefined metadata keywords, for example.

FIG. 3 illustrates a processing system 300 according to one implementation. As shown, processing system 300 may include a web front end 305, a back-end server 310, and a composite database 315. Web front end 305 may receive commands or instructions in a programming language that conforms to appropriate standards and protocols (such as the Hypertext Transfer Protocol (HTTP) protocols). Such commands may correspond to a search by a user for messages satisfying user specified search criteria (called a search query) for an email messaging program, for example, and relay such instructions to a designated email back-end server 360. Such commands may be received as electrical signals. Back-end server 310 may include a mail request processor 320 and a database accessor 325. Mail request processor 320 may receive search queries relating to an electronic mail program and provide such search queries to database accessor 325. Such queries may be received as electrical signals.

Database accessor 325 may format such search queries into Structured Query Language (SQL) format, for example, and provide such formatted search queries as electrical signals to a database engine denoted herein as SQL engine 330. Such a database (SQL) engine 330 may interface with a virtual table accessor 335. Virtual table accessor 335 may include a flat file virtual table accessor 340 and a relational database table accessor 345. Flat file virtual table accessor 340 may be adapted to access data store in an appropriate internal flat file virtual table within the composite database 315, and relational database table accessor 345 may be adapted to access an appropriate internal relational table within the composite database 315, for example. Composite database 315 may include one or more tables, such as a first table 355 and a second table 360. Composite database 315 may also include one or more indexes, such as a first index 365 and a second index 370.

Virtual table accessor 335 may present a single interface to the underlying SQL engine 330 such that a partition between the internal flat file virtual table accessor 340 and the internal relational table accessor 345 is not observable, i.e., is transparent to a remote user or process. Server 310 may also include a cache memory 350 for storing certain frequently used data as electrical signals, for example. In summary, a composite database 315 may comprise a set of one or more composite database tables that in turn may be viewed as comprising a set of one or more internal flat file virtual tables and a related set of one or more internal relational database tables.

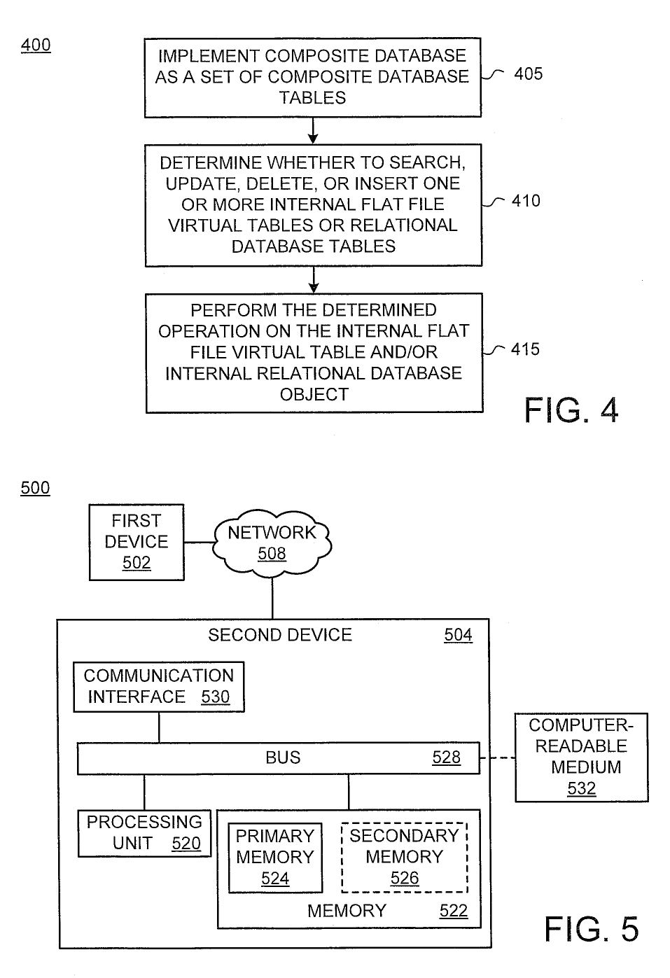

FIG. 4 illustrates a method 400 of utilizing a composite database according to one implementation. First, at operation 405, a composite database comprising a set of composite database tables is implemented. The set of composite database tables may comprise a set of appropriate internal flat file virtual tables and a related set of relational database tables. A composite database table may allocate records or other data to an internal flat file virtual table based on predefined criteria and allocate the remaining data to be stored in the composite database table to a related internal relational database table. Next, at operation 410, a determination is made as to whether to search, update, delete, or insert one or more of the appropriate internal flat file virtual table components and/or related set of the internal relational database table components based on an application of predefined criteria to a given query or composite database transaction. Finally, at operation 415, a search, update, delete, or insert of the appropriate internal flat file virtual table component and/or the internal relational database table component may be performed based on the nature of a specific query or composite database transaction. A search, for example, may comprise searching for binary digital signals stored in one or more internal memory representations of the appropriate internal flat file virtual table or tables or the related appropriate internal relational database table component or components.

FIG. 5 is a schematic diagram illustrating a computing environment system 500 that may include one or more devices configurable to perform a search using one or more techniques illustrated above, for example, according to one implementation. System 500 may include, for example, a first device 502 and a second device 504, which may be operatively coupled together through a network 508.

First device 502 and second device 504, as shown in FIG. 5, may be representative of any device, appliance or machine that may be configurable to exchange data over network 508. First device 502 may be adapted to receive a user input from a program developer, for example. By way of example but not limitation, either of first device 502 or second device 504 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 508, as shown in FIG. 5, is representative of one or more communication links, processes, and/or resources configurable to support the exchange of data between first device 502 and second device 504. By way of example but not limitation, network 508 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

It is recognized that all or part of the various devices and networks shown in system 500, and the processes and methods as further described herein, may be implemented using or otherwise include hardware, firmware, software, or any combination thereof.

Thus, by way of example but not limitation, second device 504 may include at least one processing unit 520 that is operatively coupled to a memory 522 through a bus 528.

Processing unit 520 is representative of one or more circuits configurable to perform at least a portion of a data computing procedure or process. By way of example but not limitation, processing unit 520 may include one or more processors, controllers, microprocessors, microcontrollers, application specific integrated circuits, digital signal processors, programmable logic devices, field programmable gate arrays, and the like, or any combination thereof.

Memory 522 is representative of any data storage mechanism. Memory 522 may include, for example, a primary memory 524 and/or a secondary memory 526. Primary memory 524 may include, for example, a random access memory, read only memory, etc. While illustrated in this example as being separate from processing unit 520, it should be understood that all or part of primary memory 524 may be provided within or otherwise co-located/coupled with processing unit 520.

Secondary memory 526 may include, for example, the same or similar type of memory as primary memory and/or one or more data storage devices or systems, such as, for example, a disk drive, an optical disc drive, a tape drive, a solid state memory drive, etc. In certain implementations, secondary memory 526 may be operatively receptive of, or otherwise configurable to couple to, a computer-readable medium 532. Computer-readable medium 532 may include, for example, any medium that can carry and/or make accessible data, code and/or instructions for one or more of the devices in system 500.

Second device 504 may include, for example, a communication interface 530 that provides for or otherwise supports the operative coupling of second device 504 to at least network 508. By way of example but not limitation, communication interface 530 may include a network interface device or card, a modem, a router, a switch, a transceiver, and the like.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising:
executing instructions, by a special purpose computing device, to direct the special purpose computing device to:
receive first binary digital signals from a communications network and representative of a query for a composite database, wherein data for the composite database is allocated to at least one internal flat file virtual table based on predefined criteria and remaining data for the composite database is allocated to one or more internal relational database tables;
determine whether to search at least one of the one or more internal flat file virtual tables and/or the one or more internal relational database tables based on an application of the predefined criteria to the query; and
perform a search of second binary digital signals stored in one or more memories accessible by the special purpose computing device and representative of the data associated with the one or more internal flat file virtual tables, or of the remaining data associated with the one or more internal relational database tables based on the determination of whether to search the one or more internal flat file virtual tables and/or the one or more relational database tables.

2. The method of claim 1, wherein the composite database comprises one or more composite database tables, each of the composite database tables comprising the one or more internal flat file virtual tables and the one or more internal relational database tables.

3. The method of claim 1, wherein the instructions, in response to being executed by a second special purpose computing device, are adapted to direct the second special purpose computing device to allocate the data to the one or more internal flat file virtual tables based on the predefined criteria and the remaining data to the one or more internal relational database tables.

4. The method of claim 1, wherein the search of the one or more internal relational database tables comprises searching a b-tree database.

5. The method of claim 1, wherein the search comprises searching for metadata stored as the second binary digital signals in at least one of the one or more internal flat file virtual tables or the one or more internal relational database tables.

6. The method of claim 1, wherein the instructions, in response to being executed by the special purpose computing device, are adapted to direct the special purpose computing device to selectively retrieve the second binary digital signals representative of data blocks corresponding to at least one of the one or more internal flat file virtual tables and/or the one or more internal relational database tables based at least in part on the query.

7. The method of claim 1, wherein the composite database is adapted to store metadata corresponding to an electronic mail application program.

8. A system comprising:
one or more special purpose computing devices adapted to:
implement a composite database, wherein data for the composite database is allocated to at least one internal flat file virtual table based on predefined criteria and remaining data for the composite database is allocated to one or more internal relational database tables;
receive a query for a search of the composite database and determine whether to search at least one of the one or more internal flat file virtual tables and/or the one or more internal relational database tables based on an application of the predefined criteria to the query; and
perform a search of second binary digital signals stored in one or more memories accessible by the special purpose computing device and representative of the data associated with the one or more internal flat file virtual tables, or of the remaining data associated with the one or more internal relational database tables based on the determination of whether to search the one or more internal flat file virtual tables and/or the one or more relational database tables.

9. The system of claim 8, wherein the one or more special purpose computing devices are adapted to allocate the data to the one or more internal flat file virtual tables based on the predefined criteria and the remaining data to the one or more internal relational database tables.

10. The system of claim 8, wherein the predefined criteria comprises a date associated with binary digital signals representative of data stored in the composite database.

11. The system of claim 8, wherein the special purpose computing device is further adapted to store metadata associated with electronic mail messages as the second binary digital signals in the composite database.

12. The system of claim 8, wherein the special purpose computing device is further adapted to selectively retrieve the second binary digital signals representative of data blocks corresponding to at least one of the one or more internal flat file virtual tables or the one or more internal relational database tables based on the search.

13. The apparatus of claim 8, wherein the one or more internal flat file virtual tables are adapted to store data as the first binary digital signals representative of first data blocks having a first size, and the one or more internal relational database tables are adapted to store the second binary digital signals representative of the remaining data in second data blocks having a second size, wherein the first size is different from the second size.

14. The apparatus of claim 8, wherein the searching the one or more internal relational databases comprises searching at least one b-tree database.

15. An article comprising:
a storage medium comprising machine readable instructions stored thereon which, in response to being executed by a special purpose computing device, are adapted to direct the special purpose computing device to:
receive first binary digital signals from a communications network and representative of a query for a composite database, wherein data for the composite database is allocated to at least one internal flat file virtual table based on predefined criteria and remaining data for the composite database is allocated to one or more internal relational database tables;
determine whether to search at least one of the one or more internal flat file virtual tables and/or the one or more internal relational database tables based on an application of the predefined criteria to the query; and
perform a search of second binary digital signals stored in one or more memories accessible by the special purpose computing device and representative of the data associated with the one or more internal flat file virtual tables, or of the remaining data associated with the one or more internal relational database tables based on the determination of whether to search the one or more internal flat file virtual tables and/or the one or more relational database tables.

16. The article of claim 15, wherein the machine readable instructions, in response to being executed by a second special purpose computing device, are adapted to enable the second special purpose computing device to allocate the data to the one or more internal flat file virtual tables based on the predefined criteria and the remaining data to the one or more internal relational database tables.

17. The article of claim 15, wherein the machine readable instructions, in response to being executed by the special purpose computing device, are adapted to search for metadata stored as the second binary digital signals in at least one of the one or more internal flat file virtual tables or the one or more internal relational database tables.

18. The article of claim 15, wherein the machine readable instructions, in response to being executed by the special purpose computing device, are adapted to enable the special purpose computing device to selectively store in and/or retrieve data blocks corresponding to at least one of the one or more internal flat file virtual tables or the one or more internal relational database tables based on the query.
